(19) United States
(12) Patent Application Publication
(10) Pub. No.: US 2004/0258818 A1
(43) Pub. Date: Dec. 23, 2004

(54) Reduced acidic flavor in acidified starch products

(75) Inventors: Andrew E. McPherson, Mount Prospect, IL (US); John H. Pasch, Lake Zurich, IL (US); Yeong Ching A. Hong, Kildeer, IL (US); Veronica Harrison, Bartlett, IL (US); Lynell Morales, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/601,231

(22) Filed: Jun. 20, 2003

(51) Int. Cl. A21D 6/00

(52) U.S. Cl. 426/496

(57) ABSTRACT

The present invention is directed to acidified starch products having reduced acid flavors and microbiological stability, and to methods for making those products. In accordance with the invention, an acidified starch product is prepared by preparing a dough and contacting the dough with an effective amount of high intensity sweetener and food grade acid.

The present invention relates to acidified starch products having reduced acid flavors and methods for making those products. More particularly, the acidified starch product includes a food grade acid and a high-intensity sweetener in amounts effective for providing a starch product with microbiological stability and without objectionable acid flavor.

### BACKGROUND

The growing popularity of healthy foods and natural foods has greatly increased the use of more natural methods of preventing food spoilage without use of the chemical food preservatives. Most common food spoilage problems are caused by unwanted growth of bacteria, yeasts and molds. The addition of food grade acids is often useful for lowering the pH to levels where the growth of microbes which are harmful to man or animals is inhibited. However, the additional of food grade acids to food compositions may result in undesirable flavors in the product.

In an effort to improve the flavor of food compositions treated with food grade acids, nutritive sweeteners or sugars have been added to the food composition. However, the use of nutritive sweeteners results in undesirable browning reactions and normally requires the use of high levels of the sweetener in the food.

### SUMMARY

The present invention is directed to an acidified starch composition with reduced acid flavors and a method for reducing acidic flavor in the acidified starch. The invention uses a combination of food grade acid and high-intensity sweeteners to providing a microbiologically stable product that does not have objectionable acid flavors.

The present invention is also directed to a method of preparing an acidified starch product, said method comprising (1) preparing a dough, (2) cooking the dough, (3) introducing an effective amount of a food grade acid into the dough or cooked dough, and (4) introducing an effective amount of a high intensity sweetener into the dough or cooked dough, where the effective amount of food grade acid and the high intensity sweetener to produce the acidified starch product having microbial stability and without objectional acid flavor.

In alternative aspects of the invention, acidified starch may be prepared by i) including a high-intensity sweetener in a dough and cooking the dough with an aqueous solution that includes a food grade acid; ii) including a high-intensity sweetener in a dough, cooking the dough and then contacting the dough with an aqueous solution that includes a food grade acid; iii) contacting or rinsing a cooked starch in a blend of a high-intensity sweetener and a food grade acid; and iv) cooking a starch in an aqueous solution of food grade acid and high-intensity sweetener.

Acidified starches suitable for use in the present invention include, for example, pasta, rice, potato products and mixtures thereof, and in an important aspect, the starch is pasta. The acidified starch product includes sufficient food grade acid to make the product microbiologically stable. In this aspect, the amount of food grade acid is effective for providing a product pH of about 4.6 or below. Suitable food grade acids include, for example, lactic acid, citric acid, phosphoric acid, fumaric acid, malic acid, tartaric acid, acetic acid, propionic acid, and the like as well as mixture therefrom. Preferably the food grade acid is lactic acid.

High intensity sweeteners useful in the present invention include sucralose, saccharin, acesulfame-K, cyclamates and mixtures thereof. Preferably the high intensity sweetener is sucralose. The high intensity sweeteners are used in amounts effective for eliminating objectionable flavors which may occur as a result of the use of food grade acids. These high-intensity sweeteners do not participate or contribute to browning reactions that may occur with natural sugars.

Incorporating High-Intensity Sweetener into a Dough

High intensity sweeteners may be incorporated directly into a starch based dough. The dough that includes the high intensity sweetener may then be cooked in an aqueous solution that includes a food grade acid. Alternatively, the dough that includes a high intensity sweetener may be cooked and then contacted with an aqueous solution that includes a food grade acid.

In accordance with this aspect of the invention, from about 0.0001 to about 0.01 weight percent high intensity sweetener, preferably 0.0002 to about 0.005 weight percent high intensity sweetener, based on the total weight of a final dough product, is combined with water and flour to yield a formable dough.

In one aspect, dough that includes high-intensity sweetener may be formed into desirable shapes, such as for example by extrusion, and then cooked in water using standard methods. The cooked dough may the be contacted with an aqueous composition that includes a food grade acid.

In another aspect, dough that includes a high-intensity sweetener may be cooked in an aqueous solution that includes a food grade acid. In this aspect, dough may be formed into desirable shapes and then cooked in an aqueous solution that includes a food grade acid.

Contacting Cooked Starch with High-Intensity Sweetener and Food Grade Acid

In accordance with one method of the invention, a cooked starch is contacted, for example with dipping, spraying or rinsing, with an aqueous blend of food grade acid and high-intensity sweetener. For example, the blend may include from about 0.005 to about 0.2 weight percent, preferably from about 0.01 to about 0.1 weight percent high-intensity sweetener, based on the total weight of the aqueous blend.

The aqueous blend of food grade acid and high intensity sweetener also includes sufficient amount of one or mixture of food grade acids in order to make the finish products reach target pH of 4.6 or below.

Cooked starch may be contacted with the blend of food grade acid and high intensity sweetener by spraying, dipping and through the use of a coating drum. The high-intensity sweetener and food grade acid blend may be spayed on cooked pasta at about 4 to about 8 weight percentage of cooked pasta at a temperature ranged from about 50 to about 100° C. in the coating drum. The blend of food grade acid and high intensity sweetener is contacted with the cooked starch for about 1 to about 7 minutes, preferably about 3 to about 5 minutes.

Cooking Starch with High-Intensity Sweetener and Food Grade Acid

In another aspect of the invention, starch may be cooked in an aqueous solution of food grade acid and high intensity sweetener. In this aspect of the invention, the starch is cooked in an aqueous solution that includes about 0.1 to about 0.5 weight percent food grade acid and from about 0.0001 to about 0.005 weight percent high intensity sweeteners, based on the total weight of the aqueous solution. More preferably, high intensity sweetener concentrations in the aqueous acid solution are about 0.0002 to about 0.0015 weight percent, based on the total weight of the aqueous acid solution. Cooking is conducted by contacting the starch with the aqueous solution of food grade acid and high intensity sweetener at a temperature of about 90 to about 100° C. for an amount of time effective for cooking the starch. The concentration of acid solution is depended on strength of acid and cooking time. The amount of food grade acid added should be effective for providing a final pH of 4.6 or below.

### DETAILED DESCRIPTION

The present invention is directed to a starch that contains or is contacted with a high-intensity sweetener and contacted with a food grade acid to provide a commercially sterile, acidified shelf stable product. The product does not have objectionable flavors that may be associated with food grade acids. As used herein, “microbiologically stable” or “microbiological stability” refers to the condition of commercially sterile as defined by the United States Food and Drug Administration 21CFR113 and 21CFR114.

High-Intensity Sweeteners

Sweeteners useful in the present invention are high intensity sweeteners. High intensity sweeteners useful in the present invention include sucralose, saccharin, acesulfame-K, cyclamates, and mixtures thereof. With respect to sucrose having a perceived sweetness of 1.0, the sweetness of high intensity sweeteners are as follow: sucralose, 450-600; saccharin, 300; acesulfame-K, 200; and cyclamate, 30 (Alternate Sweeteners, 1985, 1. O'Brien Nabors and R. C. Gelardi, Marcel Dekker, New York). These high intensity sweeteners do not participate or contribute to browning reactions that may occur with natural sugars. The high intensity sweeteners may be used at much lower levels than sugars. As used herein, the term “sweetener” means a composition which is not intended for oral consumption by itself, but rather is intended for consumption together with the substance being sweetened or made sweeter. Sweeteners are typically granular in form, but can be in any other suitable form such as powder, liquid or syrup.

An important high intensity sweetener in the present invention is sucraloase. “Sucralose” is also known as 1,6-dichloro-1,6-dideoxy-β-D-fructo-furanosyl-4-chloro-4-deoxy-α-D-galactopyranoside; 4,1′,6′-trichloro-4,1′, 6′-trideoxy-galacto-sucrose; 1′,4,6′-trichloro-galactosucrose; and TGS. Sucralose has the general formula C₁₂H₁₉Cl₃O₈ and a molecular weight of 397.64. References which disclose methods for preparing sucralose include European Pat. Application 0 030 804 to Tate et al. and U.S. Pat. No. 4,343,934 to Jenner et al. U.S. Pat. No. 4,435,440 to Hough et al. describes the usefulness of sucralose as a sweetener. These references are hereby incorporated by reference.

Sucralose is non-nutritive sweetner which tastes very similar to sucrose while possessing some advantages over nutritive sweetners. Because sucralose is approximately 450-600 times sweeter than sucrose, even a small amount of sucralose is sufficient to disguise a bitter taste. Additionally, sucralose is very stable across a wide pH range and does not lose its sweetness when mixed with other food ingredients and food grade acids and after cooking and drying processes.

Food Grade Acids

The food grade acids of the present invention provide the product with a desired microbiological stability. As used herein “microbiological stability” means products that are processed and packaged to be commercially sterile. Commercial stability is defined by the FDA as the condition achieved by application of heat, or other appropriate treatment that renders the product and container free of viable microorganisms having public health significance, as well as microorganisms of non-health significance, capable of reproducing in the food under the normal non-refrigerated conditions in which the food is stored, distributed, retailed and held by the user. Acidified foods means low-acid foods to which acid(s) or acid food(s) are added; these foods include, but are not limited to, beans, cucumbers, cabbage, artichokes, cauliflower, puddings, peppers, tropical fruits, and fish, singly or in any combination. They have a water activity (Aw) greater than 0.85 and have a finished equilibrium pH of 4.6 or below (From 21CFR 113 “Low Acid Canned Foods” and 21CFR 114 “Acidified Foods”). Food grade acids useful in the present invention include lactic acid, citric acid, phosphoric acid, fumaric acid, malic acid, tartaric acid, acetic acid, proprionic acid, and mixtures thereof.

Starch

The present invention provides starch foods or starch containing foods that include food grade acids, do not have acidic flavors, and which retain all desirable functions of the starch. Starches may include pasta, rice, potato products such as IQF, cubes, slices, whole, fries, hashbrowns mashed, fried, pancake dumpling by way of nonlimiting example and mixtures thereof.

Pasta is prepared from an “alimentary paste” or dough by which is meant a glutinous or farinaceous flour and water mixture. Alimentary pastes or doughs are generally made from coarse, hard flours obtained from hard wheat such as the middlings of durum wheat, often referred to as “semolina flour” or “semolina”. Semolina comprises a major portion of the flour in alimentary pastes because it is highly glutinous, i.e. has a high content of the protein gluten which is capable of denaturing to provide a self-supporting pasta.

High quality, wheat-based flours are preferred in the practice of this invention. The flour should be of the glutenous type and have a minimum average protein content of about 12 to about 13.5 weight percent and preferably a minimum average protein content of about 13 to about 13.5 weight percent. Preferred wheat-based flours comprise 100 percent durum flours, 100 percent semolina flours, blends of about 25 to about 100 parts by weight durum flour and 0 to about 75 parts by weight hard red spring flour, and blends of about 25 to about 100 parts by weight semolina flour and 0 to about 75 parts by weight hard red spring flour. Especially preferred wheat-based flours include 100 percent durum flours, 100 percent semolina flours, blends of about 50 to 100 weight percent durum flour and 0 to about 50 weight percent hard red spring flour, and blends of about 50 to 100 weight percent semolina flour and 0 to about 50 weight percent hard red spring flour, wherein the flour or flour blend has a minimum average protein content between about 13 to about 13.5 weight percent. Generally flours having a granulation size such that about 98 percent minimum pass through a U.S. standard No. 70 sieve (i.e., about 210 micron openings) are acceptable.

“Pasta” herein can also include noodles and egg noodles. Noodles or egg noodles are pasta products further comprising eggs. By “noodle” or “pasta noodle” herein is meant food prepared by drying formed units of dough made from semolina, durum flour, farina flour, or any combination of two or more of these, with an egg product (e.g., liquid eggs, frozen eggs, dried eggs, egg yolks, frozen yolks, dried yolks or any combination of two or more of these), with or without water. The total solids of the pasta noodles herein preferably contains not less than 5.5% by weight of egg or egg yolk solids. Lower levels of egg or egg yolk solids such as 3-5% percent by weight are also operative herein, but would not be within the 21 CFR Section 139.150 definition of noodle products. A preferred level of egg for noodle products is 5.5% to 6.0% by weight, but the upper limit should not exceed 20% by weight.

A typical alimentary paste used to prepare pastas suitable for the present invention comprises between about 67.0% and about 80.0% by weight of wheat flour such as, but not limited to, semolina.

Pastas may be prepared by first forming a homogenous aqueous paste of flour and water containing. The flour typically has average minimum protein content of greater than about 12 weight % and preferably in the range of about 12 to 13.5 weight %. The homogenous paste is then extruded to form pasta-shaped extrudates. For purposes of this invention, the terms “pasta-shaped extrudates” or “extrudates” are intended to include both three-dimensional shapes formed with conventional extrusion techniques and dies of appropriate shape as well as thin sheets formed using conventional roller-type pasta makers and strips or other shapes cut from such thin sheets. The extrudates are dried under high temperature and low relative humidity conditions. By carefully controlling both the temperature and humidity during drying (as well established and understood in the art), a pasta is obtained which has, both before and after cooking, good color, texture, integrity, and flavor. Both egg-containing and essentially egg-free pastas can be dried by conventional methods (i.e., relatively high temperatures and relatively low humidity conditions) with excellent results.

The dried pastas of this invention have a moisture content about 13.0 weight percent and a vegetable solids content of about 4 to about 15 weight percent. For purposes of this invention, “dried pasta” is pasta having a moisture content of less than about 12.5 weight percent and preferably less than about 12 weight percent. Preferably, the dried pasta of this invention have at least 11 weight percent moisture.

Uncooked pasta may be prepared in the present invention from any formulation known in the art. By “uncooked” is meant pasta wherein a major portion, i.e., greater than about 80% by weight of the total starch content, is ungelatinized. The term “cooking” as used herein refers to the process of heating the pasta in order to gelatinize the starch.

The following examples illustrate methods for carrying out the invention and should be understood to be illustrative of, but not limiting upon, the scope of the invention which is defined in the appended claims.

### EXAMPLES

### Example 1

### Spray On (or Rinse)

1. Pasta is extruded by conventional means. Pasta is dried in a standard pasta dryer to a fixed moisture content. Typically to 12% moisture.

2. Pasta is cooked by immersion in water in a rotary blancher for 2 to 20 minutes preferably 4 to 10 minutes. Moisture content of cooked pasta is typically 50-60%

3. Cooked pasta is transported to coating drum whereby a slurry consisting of acid and high-intensity sweetener is sprayed onto the pasta. Concentration of the high-intensity sweetener is dependent on pasta shape and contact time. Typically, at a level of 0.01% to 0.2%. Preferably 0.01 to 0.1%.

4. Residence time in the coating drum is typically 1-7 minutes preferably 3-5 minutes.

Results of a consumer test for spaghetti were as follows. Compared to control (no high-intensity sweetener present) vs above described process, the overall liking score increased to 7.1 from 6.4 based on a nine-point scale (with nine being the most liked).

### Example 2

### In the Pasta

1. Water containing 0.004% sucralose is combined with semolina and/or duram flour at a ratio of 30:70 to yield a formable dough. The dough is formed and dried into various pasta shapes. Drying under forced air over 8-12 hours yielded finished pasta with a moisture content of 12% moisture. The pasta is then cooked in water containing a food grade acid.

2. Results of a consumer test for rotini were as follow. Compared to control (no high-intensity sweetener present) vs. above described process, the overall liking score increased to 7.4 from 6.5 based on the same nine-point scale as in Example 1.

### Example 3

### For Acidified Rice with Sucralose (Cooked in Acid Water Containing Sucralose)

Five different four one-liter acid solutions containing 0.2% of 88% lactic acid, with 0, 2, 5, 8, or 10 ppm of sucralose were prepared. These solutions were heated till boiling. One pouch (10 g) of Minute-Rice was placed in each boiling acid solution, and boiled over for 3 to 5 minutes. These cooked acidified rice were drained and fluffed with fork. All these rice samples had a pH at about 3.95. An expert panel then evaluated these samples. The sample treated with 5, 8 or 10 ppm sucralose in acid solution was too sweet. The sample treated with 2 ppm of sucralose in acid solution had a reduced acid taste related to the sample prepared without sucralose.

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. An acidified starch comprising:
from about 0.0001 to about 0.01 weight percent high-intensity sweetener; and an amount of food grade acid effective for providing a pH of 4.6 or less.

2. The acidified starch of claim 1 wherein the high-intensity sweetener is selected from the group consisting of sucralose, aspartame, saccharin, acesulfame-K, cyclamate and mixtures thereof.

3. The acidified starch of claim 2 wherein the high-intensity sweetener is sucralose.

4. The acidified starch of claim 1 wherein the food grade acid is selected from the group consisting of lactic acid, citric acid, phosphoric acid, fumaric acid, malic acid, tartaric acid, acetic acid, propionic acid and mixtures thereof.

5. The acidified starch of claim 4 wherein the food grade acid is lactic acid.

6. The method of claim 1 wherein the starch is selected from the group consisting of pasta, rice, potato products and mixtures thereof.

7. The method of claim 6 wherein the starch is pasta.

8. A method of preparing an acidified starch comprising:
forming a dough by combining flour with a water composition in an amount effective for providing 0.0001 to 0.005 weight percent high-intensity sweetener, based on a total weight of the dough;
forming the dough into desired shapes;
cooking the dough; and
contacting the cooked dough with an aqueous composition that includes a food grade acid.

9. The method of claim 6 wherein the aqueous composition includes an amount of food grade acid effective for providing a starch having a pH of 4.6 or less.

10. The method of claim 8 wherein the high-intensity sweetener is selected from the group consisting of sucralose, aspartame, saccharin, acesulfame-K, cyclamate and mixtures thereof.

11. The method of claim 10 wherein the high-intensity sweetener is sucralose.

12. The method of claim 8 wherein the food grade acid is selected from the group consisting of lactic acid, citric acid, phosphoric acid, fumaric acid, malic acid, tartaric acid, acetic acid, propionic acid, and mixtures thereof.

13. The method of claim 12 wherein the food grade acid is lactic acid.

14. The method of claim 8 wherein the starch is selected from the group consisting of pasta, rice, potato products and mixtures thereof.

15. The method of claim 14 wherein the starch is pasta.

16. A method of preparing an acidified starch comprising:
forming a dough by combining flour with a water composition in an amount effective for 0.0001 to about 0.005 weight percent high-intensity sweetener, based on a total weight of the dough;
forming the dough into desired shapes; and
cooking the dough in an aqueous composition that includes a food grade acid.

17. The method of claim 16 wherein the aqueous composition includes an amount of food grade acid effective for providing a starch having a pH of 4.6 or less.

18. The method of claim 16 wherein the high-intensity sweetener is selected from the group consisting of sucralose, aspartame, saccharin, acesulfame-K, cyclamate and mixtures thereof.

19. The method of claim 18 wherein the high-intensity sweetener is sucralose.

20. The method of claim 16 wherein the food grade acid is selected from the group consisting of lactic acid, citric acid, phosphoric acid, fumaric acid, malic acid, tartaric acid, acetic acid, propionic acid and mixtures thereof.

21. The method of claim 20 wherein the food grade acid is lactic acid.

22. The method of claim 16 wherein the starch is selected from the group consisting of pasta, rice, potato products and mixtures thereof.

23. The method of claim 22 wherein the starch is pasta.

24. A method for reducing acidic flavor in acidified starch, the method comprising contacting a cooked starch with a blend of food grade acid and high-intensity sweetener.

25. The method of claim 24 wherein the blend of food grade acid and high-intensity sweetener includes 0.005 to 0.2 weight percent high-intensity sweetener, based on the total weight of the blend.

26. The method of claim 25 wherein the blend of food grade acid and high-intensity sweetener includes 0.01 to 0.1 weight percent high-intensity sweetener, based on the total weight of the blend.

27. The method of claim 24 wherein the high-intensity sweetener is selected from the group consisting of sucralose, aspartame, saccharin, acesulfame-K, cyclamate and mixtures thereof.

28. The method of claim 27 wherein the high-intensity sweetener is sucralose.

29. The method of claim 24 wherein the blend of food grade acid and high-intensity sweetener includes includes an amount of food grade acid effective for providing a starch having a pH of 4.6 or less.

30. The method of claim 24 wherein the food grade acid is selected from the group consisting of lactic acid, citric acid, phosphoric acid, fumaric acid, malic acid, tartaric acid, acetic acid, propionic acid and mixtures thereof.

31. The method of claim 30 wherein the food grade acid is lactic acid.

32. The method of claim 24 wherein the starch is selected from the group consisting of pasta, rice, potato products and mixtures thereof.

33. The method of claim 32 wherein the starch is pasta.

34. The method of claim 24 wherein the blend of food grade acid and high-intensity sweetener is contacted with the cooked starch in a coating drum for 1 to 7 minutes.

35. The method of claim 34 wherein the blend of food grade acid and high-intensity sweetener is contacted with the cooked starch in a coating drum for 3 to 5 minutes.

36. A method for preparing an acidified starch, the method comprising contacting starch with an aqueous solution of a food grade acid and high-intensity sweetener for a time and temperature effective for cooking the starch.

37. The method of claim 36 wherein the starch is cooked at a temperature of from about 90° C. to about 100° C. for at least about 3 minutes.

38. The method of claim 36 wherein the aqueous solution includes about 0.005 to about 0.2 weight percent high-intensity sweetener, based on the total weight of the aqueous solution.

39. The method of claim 38 wherein the aqueous solution includes about 0.01 to about 0.1 weight percent high-intensity sweetener, based on the total weight of the aqueous solution.

40. The method of claim 36 wherein the high-intensity sweetener is selected from the group consisting of sucralose, aspartame, saccharin, acesulfame-K, cyclamate and mixtures thereof.

41. The method of claim 40 wherein the high-intensity sweetener is sucralose.

42. The method of claim 36 wherein the aqueous solution of food grade acid and high-intensity sweetener includes includes an amount of food grade acid effective for providing a starch having a pH of 4.6 or less.

43. The method of claim 36 wherein the food grade acid is selected from the group consisting of lactic acid, citric acid, phosphoric acid, fumaric acid, malic acid, tartaric acid, acetic acid, propionic acid and mixtures thereof.

44. The method of claim 43 wherein the food grade acid is lactic acid.

45. The method of claim 36 wherein the starch is selected from the group consisting of pasta, rice, potato products and mixtures thereof.

46. The method of claim 45 wherein the starch is pasta.

47. A method of preparing an acidified starch product, the method comprising:
preparing the dough;
cooking the dough;
introducing an effective amount of a food grade acid into the dough or cooked dough; and
introducing an effective amount of a high intensity sweetener into the dough or cooked dough;
wherein the effective amount of food grade acid and high intensity sweetener is effective for providing an acidified starch product having microbial stability and without objectionable acid flavor.

48. The method of claim 47 wherein the amount of food grade acid is effective for providing a pH of 4.6 or less.

49. The method of claim 47 wherein the high-intensity sweetener is selected from the group consisting of sucralose, aspartame, saccharin, acesulfame-K, cyclamate and mixtures thereof.

50. The method of claim 49 wherein the high-intensity sweetener is sucralose.

51. The method of claim 50 wherein the food grade acid is selected from the group consisting of lactic acid, citric acid, phosphoric acid, fumaric acid, malic acid, tartaric acid, acetic acid, propionic acid, and mixtures thereof.

52. The method of claim 51 wherein the food grade acid is lactic acid.

53. The method of claim 47 wherein the starch is selected from the group consisting of pasta, rice, potato products and mixtures thereof.

54. The method of claim 53 wherein the starch is pasta.
